(19) United States
(12) Patent Application Publication
(10) Pub. No.: US 2026/0267145 A1
(43) Pub. Date: Sep. 10, 2026

(54) HEAD-MOUNTED DEVICE CONFIGURED FOR TOUCHLESS HAND GESTURE INTERACTION

(71) Applicant: GOOGLE LLC, Mountain View, CA (US)

(72) Inventors: Dongeek Shin, San Jose, CA (US); Chung Chun Wan, San Jose, CA (US); Jonathan James Taylor, New York City, NY (US); Sasa Petrovic, Zurich (CH); Min Kang, New York, NY (US); Danhang Tang, West Hollywood, CA (US); Adarsh Prakash Murthy Kowdle, San Francisco, CA (US)

(21) Appl. No.: 19/164,108

(22) PCT Filed: Apr. 6, 2023
(86) PCT No.: PCT/US2023/017742

§ 371 Date: Sep. 10, 2025

(51) Int. Cl. G02B 27/01; G02B 27/00; G06F 1/16; G06F 3/01; G06F 3/04815; G06F 3/0482; G06T 7/246; G06V 10/44; G06V 10/82; G06V 40/20

(52) U.S. Cl. CPC G02B 27/0172; G02B 27/0093; G06F 1/163; G06F 3/017; G06F 3/04815; G06F 3/0482; G06T 7/251; G06V 10/44; G06V 10/82; G06V 40/28; G02B 2027/0138; G02B 2027/014; G02B 2027/0178; G06T 2207/20084; G06T 2207/30196

(57) ABSTRACT

Touchless interaction with a head-mounted device may require more power than practical. The disclosed techniques address this problem, and others, by describing a sparse keypoint, hand-modeling technique that can reduce the computation and power required for recognizing a dynamic gesture. The power requirements for the touchless interaction may be further reduced by performing this modeling and recognition only when a hand is detected in a field-of-view of the head mounted device and by using a split-computing architecture with a companion device. The disclosed hand modeling and tracking techniques may be further applied to other applications, such as locking a rendered element in an augmented reality environment to the hand of a user.

### FIELD OF THE DISCLOSURE

The present disclosure relates to a head-mounted device and more specifically to a head-mounted device configured for augmented-reality (i.e., AR) interaction with a user (i.e., wearer).

### BACKGROUND

A head-mounted (i.e., head-worn) device, such as smart glasses, may include a heads-up display (i.e., HUD) configured to display a user-interface (UI) to an eye (or eyes) of a user. The UI can be superimposed on a physical environment so that the user can interact with physical objects of the real world in a virtual way. This interaction may require the user to perform a gesture in order to control, or otherwise participate in, the interaction.

### SUMMARY

The present disclosure describes a head-mounted device configured for touchless interaction with a user. In particular, the disclosed head-mounted device is configured to detect and recognize a movement of a user's fingers as a moving gesture (i.e., dynamic gesture) conveying an action, such as a “click” or a “scroll.” The disclosed approach combines low-power and high-power processes in a framework for detecting, recognizing, and responding to the dynamic gestures that lowers an average power consumed by the head-mounted device so that its operating life is not dominated by the touchless interaction capability that it provides.

In some aspects, the techniques described herein relate to a head-mounted device including: a camera configured to: capture low-resolution images of a field-of-view (e.g., continuously); and capture high-resolution images of the field-of-view in response to being triggered by a trigger signal; a first processor configured to: generate the trigger signal in response to (e.g., during) a hand being identified in the low-resolution images; and a second processor activated by the trigger signal to: determine a set of keypoints for each of the high-resolution images, the set of keypoints for each high-resolution image corresponding to locations on the hand in the field-of-view. In some aspects, the techniques described herein relate to a system, comprising the head-mounted device and a companion device in communication with the head-mounted device, the companion device including a third processor configured to receive the set of keypoints from the head-mounted device, generate a rendered element based on the set of keypoints, and transmit the rendered element to the head-mounted device for display.

In some aspects, the techniques described herein relate to a method for tracking a movement of a hand, the method including: configuring a camera to capture low-resolution images of a field-of-view (e.g., continuously); detecting a hand in the low-resolution images; triggering the camera to capture high-resolution images of the field-of-view while the hand is recognized in the low-resolution images; determine a set of keypoints for each of the high-resolution images corresponding to locations on the hand in the field-of-view; and track movements of the set of keypoints over time.

In some aspects, the techniques described herein relate to a system for dynamic gesture detection including: a head-mounted device including: a camera configured to: capture low-resolution images of a field-of-view continuously; and capture high-resolution images of the field-of-view while being triggered by a trigger signal; a first processor configured to: generate the trigger signal while a hand is recognized in the low-resolution images; and a second processor activated by the trigger signal to: determine a keypoint (or set of keypoints) for each of the high-resolution images, the keypoint (or set of keypoints) for each high-resolution image corresponding to a location on the hand in the field-of-view; track movements of the keypoint (or set of keypoints) over time; and detect a dynamic gesture based on the movements of the keypoint (or set of keypoints) over time; and a companion device in communication with the head-mounted device, the companion device including a third processor configured to: receive the dynamic gesture from the head-mounted device; generate a rendered element based on the dynamic gesture; and transmit the rendered element to the head-mounted device for display.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a perspective view of a head-mounted device according to an implementation of the present disclosure.

FIG. 2 is a perspective view of a hand as seen and imaged by a head-mounted device according to a possible implementation of the present disclosure.

FIG. 3A is a state diagram of a head-mounted device according to a possible implementation of the present disclosure.

FIG. 3B is a graph illustrating a power consumed in a head-mounted device according to a possible implementation of the present disclosure.

FIG. 4 is a block diagram of a system for dynamic gesture detection according to a possible implementation of the present disclosure.

FIG. 5 illustrates a key-point model of a hand according to a possible implementation of the present disclosure.

FIG. 6A illustrates a first possible dynamic gesture according to an implementation of the present disclosure.

FIG. 6B illustrates a second possible dynamic gesture according to an implementation of the present disclosure.

FIG. 7 illustrates a palm-locked rendered element as seen through an augmented reality display according to an implementation of the present disclosure.

FIG. 8 is a flow chart of a method for tracking a movement of a hand according to an implementation of the present disclosure.

FIG. 9 is a system block diagram of a head-mounted device according to a possible implementation of the present disclosure.

The components in the drawings are not necessarily to scale relative to each other. Like reference numerals designate corresponding parts throughout the several views.

### DETAILED DESCRIPTION

Configuring a head-worn device, such as smart glasses, to recognize dynamic hand gestures, which do not require touching the head-worn device (i.e., touchless gestures), may increase usability and expand potential interactions. Power requirements for touchless gesture recognition, however, may be higher than reasonable for such devices due to their limited battery capacity. While a peripheral device (e.g., smart watch) can make the gesture recognition consume less of the head-worn device's stored power, it can increase the cost/complexity of the overall system. A need exists for touchless gesture recognition for head-worn devices that balances technical feasibility (i.e., does not quickly drain the battery) with user experience (e.g., is simple and transparent to a user).

The present disclosure describes power-efficient techniques for tracking the movement of a hand which can enable the recognition of a dynamic hand gesture (i.e., dynamic gesture). The disclosed approach can consume less power than other approaches and may not require extra sensors and/or peripheral devices, which could add complexity to the system. Accordingly, the disclosed approach may have the technical advantage of extending the operating life of the head-worn device and expanding its capabilities without adding significant complexity.

Aspects of the power-efficient hand tracking can be utilized for other purposes besides gesture recognition. Accordingly, the present disclosure further describes a display rendering technique for a head-mounted device that can locate, shape (i.e., warp), and display an element on a palm of the user.

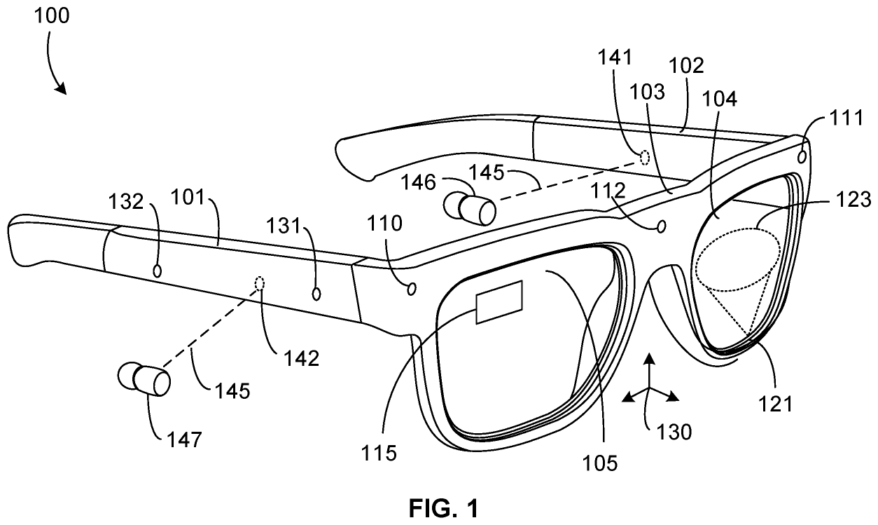

FIG. 1 is a head-worn device according to an implementation of the present disclosure. As shown, the head-worn device may be implemented as smart glasses configured for augmented reality (i.e., AR glasses).

Head-mounted device 100 are configured to be worn on the head and face of a user. The head-mounted device 100 includes a right earpiece 101 and a left earpiece 102 that are supported by the ears of a user. The head-mounted device 100 further includes a bridge portion 103 that is supported by the nose of the user so that a left lens 104 and a right lens 105 can be positioned in front a left eye of the user and a right eye of the user respectively. The portions of the head-mounted device 100 can be collectively referred to as the frame of the AR glasses. The frame of the AR glasses can contain electronics to enable function. For example, the frame may include a battery, a processor, a memory (e.g., non-transitory computer readable medium), electronics to support sensors (e.g., cameras, depth sensors, etc.), at least one position sensor (e.g., an inertial measurement unit) and interface devices (e.g., speakers, display, network adapter, etc.). The AR glasses may display and sense an environment relative to a coordinate system 130. The coordinate system 130 can be aligned with the head of a user wearing the AR glasses. For example, the eyes of the user may be along a line in a horizontal (e.g., LEFT/RIGHT, X-axis) direction of the coordinate system 130.

A user wearing the head-mounted device 100 can experience information displayed in an area corresponding to the lens (or lenses) so that the user can view virtual elements within their natural field of view. Accordingly, the head-mounted device 100 can further include a heads-up display (i.e., HUD) configured to display visual information at a lens (or lenses) of the AR glasses. As shown, the heads-up display may present AR data (e.g., images, graphics, text, icons, etc.) on a portion 115 of a lens (or lenses) of the AR glasses so that a user may view the AR data as the user looks through a lens of the AR glasses. In this way, the AR data can overlap with the user's view of the environment. In a possible implementation, the portion 115 can correspond to (i.e., substantially match) area(s) of the right lens 105 and/or left lens 104.

The head-mounted device 100 can include an inertial measurement unit (IMU) that is configured to track motion of the head of a user wearing the AR glasses. The IMU may be disposed within the frame of the AR glasses and aligned with the coordinate system 130 of the head-mounted device 100.

The head-mounted device 100 can include a world-camera 110 that is directed to a first camera field-of-view that overlaps with the natural field-of-view of the eyes of the user when the glasses are worn. In other words, the world-camera 110 (i.e., world-facing camera) can capture images of a view aligned with a point-of-view (POV) of a user (i.e., an egocentric view of the user).

In a possible implementation, the head-mounted device 100 can further include a depth sensor 111. The depth sensor 111 may be implemented as a second camera that is directed to a second field-of-view that overlaps with the natural field-of-view of the eyes of a user when the glasses are worn. The second camera and the world-camera 110 may be configured to capture stereoscopic images of the field of view of the user that include depth information about objects in the field of view of the user. The depth information may be generated using visual odometry and used as part of the camera measurement corresponding to the motion of the head-mounted device. In other implementations the depth sensor 111 can be implemented as another type of depth (i.e., range) sensing device, including (but not limited to) a structured light depth sensor or a lidar depth sensor. The depth sensor 111 can be configured to capture a depth image corresponding to the field-of-view of the user. The depth image includes pixels having pixel values that correspond to depths (i.e., ranges) to objects measured at positions corresponding to the pixel positions in the depth image.

In a possible implementation, the head-mounted device 100 can further include an illuminator 112 to help the imaging and/or depth sensing. For example, the illuminator 112 can be implemented as an infra-red (IR) projector configured to transmit IR light (e.g., near-infra-red light) into the environment of the user to help the world-camera 110 capture images and/or the depth sensor 111 to determine a range of an object.

The head-mounted device 100 can further include an eye-tracking sensor. The eye tracking sensor can include a right-eye camera and/or a left-eye-camera to capture eye-images of the left eye and/or right eye of the user wearing the glasses. As shown, an eye-camera 121 can be located in a portion of the frame so that a FOV 123 of the eye-camera 121 includes at least a portion (e.g., pupil, iris, retina, etc.) of the eye of the user when the AR glasses are worn.

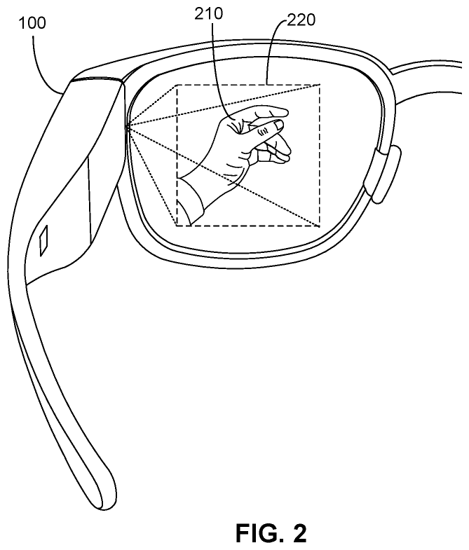

The head-mounted device 100 can further include one or more microphones. The one or more microphones can be spaced apart on the frames of the AR glasses. As shown in FIG. 2, the AR glasses can include a first microphone 131 and a second microphone 132.

The microphones may be configured to operate together as a microphone array. The microphone array can be configured to apply sound localization to determine directions of the sounds relative to the AR glasses.

The AR glasses may further include a left speaker 141 and a right speaker 142 configured to transmit audio to the user. Additionally, or alternatively, transmitting audio to a user may include transmitting the audio over a wireless communication link 145 to a listening device (e.g., hearing aid, earbud, etc.). For example, the AR glasses may transmit audio to a left wireless earbud 146 and to a right earbud 147.

The head-mounted device 100 may be configured to detect dynamic gestures of a hand based on images of the environment from a point-of-view (POV) of the user captured by the world-camera 110.

FIG. 2 illustrates a possible world-image captured by a world-camera of a head-mounted device 100 according to a possible implementation of the present disclosure. As shown, a hand 210 of a user is positioned within a user's point of view (i.e., egocentric view). The world-camera 110 of the head-mounted device 100 may have a field-of-view 220 aligned with the point-of-view of the user so that the world-image captured by the world-camera 110 substantially matches the egocentric view through the lens of the AR glasses. In this alignment, the world-image from the world-camera may be used to recognize hand gestures (e.g., static hand gestures, dynamic hand gestures).

Detecting hand gestures based on images may consume a relatively large amount of power due to the power required by the world-camera 110 for capturing high-resolution images and due to the power required by a (heavy-duty) processor for analyzing the high-resolution images (e.g., in real time). This power consumption may be inefficient because the hand gesture detection may be required infrequently during an operating period of the head-mounted device. In other words, a head-mounted device configured to continuously detect gestures could quickly deplete its battery for the sake of only a few gesture interactions. The disclosed approach addresses this technical problem by entering a hand-modeling mode (i.e., hand-tracking mode) for gesture detection only during periods in which gestures are likely and otherwise operating in a hand-detection mode. The disclosed approach can reduce consumed power (on average) because the hand-detection mode of operation may require less power than the hand-modeling mode.

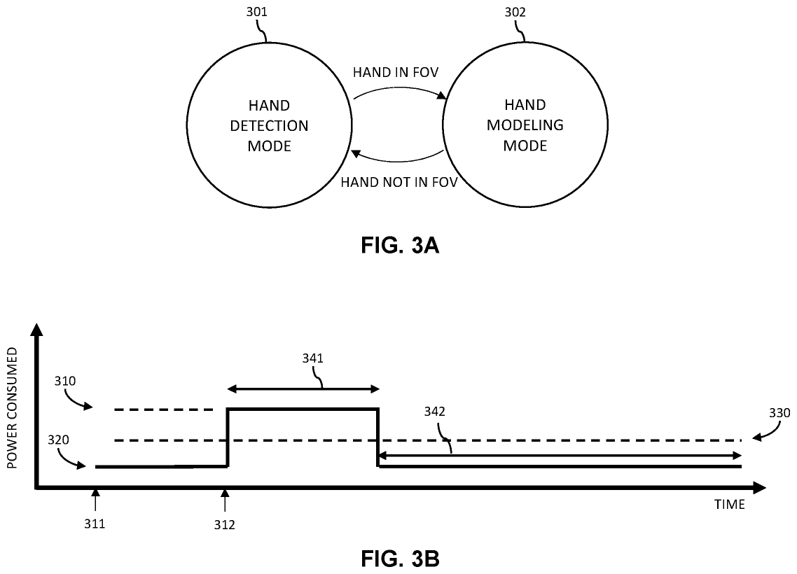

FIG. 3A illustrates a state diagram of a head-mounted device according to a possible implementation of the present disclosure. As shown, the head-mounted device 100 may be configured to operate in a hand-detection mode 301. While in the hand-detection mode 301, the head-mounted device 100 may be configured to continually search for a hand in the egocentric view of the user. This search may include using the world-camera 110 to repeatedly (e.g., periodically, continuously) capture relatively low-resolution images of the field-of-view 220. A (light-duty) processor (e.g., first processor) may be configured to analyze each captured low-resolution image in the hand-detection mode 301 to recognize a hand in the egocentric view of the user. In the description, the term “low-resolution image” can be understood as an image having a smaller number of pixels per unit are as a “high-resolution image.”

In a possible implementation, the (first) processor may be configured to analyze each low-resolution image using a neural network detector trained based on images with hands in the field-of-view 220. For example, pixels from a low-resolution image may be input to the neural network detector, which can output a signal that can indicate a hand, or no-hand, in the field-of-view 220 based on a level of the signal. A time sequence of low-resolution images can be fed to the neural network detector so that it can output a trigger signal at a first level (e.g., HIGH) while a hand is in the field-of-view and at a second level (e.g., LOW) while the hand is not in the field-of-view. The complexity of the neural network detector can be kept relatively low by using relatively low-resolution images (e.g., low-resolution, gray-scale images captured at a relatively low frame rate) and by outputting only the binary detection (i.e., trigger signal). This low complexity can correspond to a relatively low power consumed by the head-mounted device while it is operated in the hand-detection mode 301.

While the hand is detected in the field-of-view 220, the head-mounted device 100 may be configured to operate in a hand-modeling mode 302. While in the hand-modeling mode 302, the head-mounted device 100 may be configured to (i) generate a model of the hand, (ii) track a movement (or movements) of the hand based on the model, and (iii) detect a dynamic gesture based on the movement (or movements). Additionally, or alternatively, while in the hand-modeling mode 302, the head-mounted device 100 may be configured to (i) generate a model of the hand, (ii) track a movement (or movements) of the hand based on the model, and (iii) warp a display element according to a position/orientation (i.e., pose) of the hand.

Generating the hand model may include using the world-camera 110 to repeatedly (e.g., periodically, continuously) capture relatively high-resolution images of the field-of-view 220. The images for hand modeling are high-resolution compared to the low-resolution images for hand detection. A processor (e.g., second processor) may be configured to analyze each captured high-resolution image in the hand-modeling mode 302 to compute a model of the hand in the field-of-view 220. The model may include a set of keypoints representing locations (e.g., relative locations) of known points on a hand (e.g., tip of index finger, tip of thumb, etc.) in the high-resolution image.

In a possible implementation, the (second) processor may be configured to analyze each high-resolution image using a (first) neural network trained based on images with hands in the field of view in order to output a set of keypoints representing locations on the hand in the high-resolution images. Further, the (second) processor may be configured to track each keypoint over time (i.e., over successive high-resolution images) in order to determine (i.e., track) movements.

In a possible implementation the processor may be configured to analyze the movements using a (second) neural network trained based on movements for various hand-gestures (e.g., short click, long click, double click, click-and-hold, left swipe, right swipe, etc.). The complexity of the neural networks for hand modeling and/or gesture detection may be relatively high compared to the complexity of the neural network detector used for hand detection. The higher complexity may result because high-resolution images (e.g., high-resolution color images captured at a relatively high frame rate) may be required and because complex (i.e., multilayer) neural networks may be required to discern the possible outputs.

This high complexity can correspond to a relatively high power consumed by the head-mounted device while it is operated in the hand-modeling mode 302. In other words, the head-mounted device may consume low power in the hand-detection mode 301 and high power in the hand-modeling mode 302.

FIG. 3B is a graph illustrating an example power consumption for a possible implementation of the head-mounted device. At a first time 311, the head-mounted device 100 is in the hand-detection mode 301 and consumes a relatively low amount of power while searching for a hand in the field-of-view 220. At a second time 312, a hand 210 is detected in the field-of-view 220. As a result, the head-mounted device 100 is triggered to change operation to the hand-modeling mode 302 in order to model and track the detected hand 210. While in the hand-modeling mode 302, the head-mounted device 100 consumes a relatively high amount of power.

As shown in FIG. 3B, the head-mounted device 100 remains in the hand-modeling mode 302 for a first period 341. The first period 341 can be based on the hand being detected in the field-of-view 220. In a possible implementation, the low power hand detection may continue operating in parallel with the hand modeling so that when no-hand is detected, the hand modeling may end. In another possible implementation the first period 341 may end when no-hand is detected by the high-power hand modeling (e.g., no keypoints located). In either case, the head-mounted device 100 may return to the hand-detection mode 301 when the hand 210 is no longer in the field-of-view 220.

As shown in FIG. 3B, the head-mounted device 100 remains in the hand-detection mode 301 for a second period 342. The second period 342 can be based on the hand not being in the field-of-view 220. The second period 342 may be longer than the first period 341 so that an average power 330 consumed by the head-mounted device 100 is less than the high power 310 required for the hand-modeling mode 302.

In some possible implementations, the low-resolution images are used by other processes of the head-mounted device 100. In other words, the low-resolution image capture may be already accounted for in an overall power budget for the head-mounted device 100. As a result, the hand-detection using the low-resolution images may only slightly increase the power consumed by the head-mounted device 100 in the hand-detection mode 301. Further, because the periods of hand detection may be short compared to the operating life of the head-mounted device 100, the average power consumed may be comparable to the low power 320.

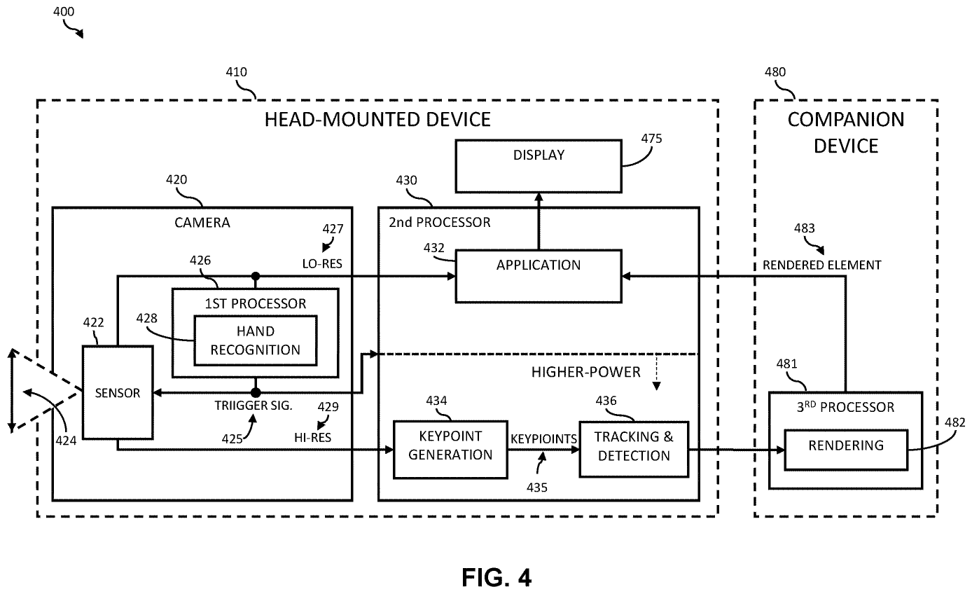

FIG. 4 is a block diagram of a system for dynamic gesture detection according to a possible implementation of the present disclosure. The system 400 includes a head-mounted device 410 communicatively coupled to a companion device 480. As discussed previously, the head-mounted device 410 can be smart glasses (e.g., AR glasses). The companion device 480 may be a computing device including (but not limited to) a mobile phone, a tablet, a laptop or the like.

The head-mounted device 410 can include a world camera (i.e., camera 420). The camera 420 can include a sensor 422 (or sensors) and optics configured to image a field-of-view 424 that is aligned with a field-of-view of a person wearing the head-mounted device 410. The sensor 422 may be configured to capture and output low-resolution images 427.

The camera 420 may include a first processor 426. The first processor 426 may be configured to facilitate the function of the camera 420. Additionally, or alternatively, the first processor may be configured to receive the low-resolution images 427 from the sensor 422 and apply the low-resolution images 427 to a hand-recognition algorithm 428 running on (i.e., performed by) the first processor 426. As described previously, the hand recognition algorithm 428 can include a neural network detector trained to detect a hand 210 based on pixels of a low-resolution image. In a possible implementation, the sensor 422 and the first processor 426 can operate as an always-on hand-detector that continuously captures and processes low-resolution images to search for a hand in the field-of-view 424.

The sensor 422 may be further configured to output high-resolution images 429 when (e.g., while) triggered by a trigger signal 425. The trigger signal 425 may be generated by the hand-recognition algorithm 428 and transmitted to the sensor 422 if, and when (e.g., while), a hand is recognized in the low-resolution images 427. The sensor 422 may be configured by the trigger signal to capture high-resolution images 429 of the field of view 424.

The head-mounted device 410 may further include a second processor 430. The second processor 430 can be physically separate from the first processor 426. The processing capabilities of the second processor 430 may be higher than the first processor 426. The second processor 430 may be configured to facilitate the functions of the head-mounted device 410. In a possible implementation, the second processor 430 is a system on a chip (SoC).

The second processor 430 may be configured to receive the high-resolution images 429 from the camera 420 and apply them to a keypoint-generation algorithm 434 running on (i.e., performed by) the second processor 430. As described previously, the keypoint-generation algorithm 434 can include a first neural network configured to output a set of keypoints 435 based on pixels of a high-resolution image 429 being applied to inputs of the first neural network. In other words, the first neural network can generate a set of keypoints based on a high-resolution image. Each keypoint in the set of keypoints may describe a location of a part of the hand. The keypoints in the set of keypoints may be connected according to their corresponding anatomical positions to form a model of the hand.

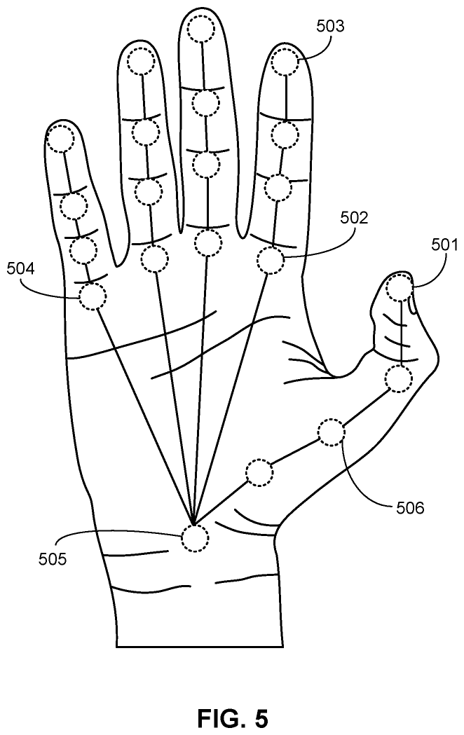

FIG. 5 illustrates a keypoint model of a hand according to a possible implementation of the present disclosure. As shown, each finger of a hand may be modeled by a plurality of keypoints (i.e., illustrated as circles). The keypoints may be located at the joints of the finger where a movement may occur and the keypoints may be linked (i.e., illustrated by lines) anatomically to form a model of the hand. As shown, a full model of the hand may require 4 keypoints per finger (i.e., 20 keypoints) plus one keypoint corresponding to the base of the hand (e.g., wrist) to which all fingers are referenced. A full keypoint model of the hand (i.e., 21 keypoints) may not be required to detect a dynamic gesture, such as a finger-swipe or a finger-pinch, which can both be formed using a thumb and index finger.

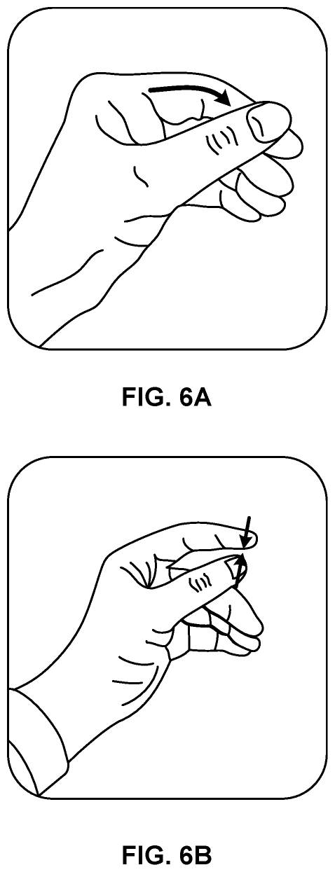

FIG. 6A illustrates a first possible dynamic gesture according to an implementation of the present disclosure. The dynamic gesture shown in FIG. 6A is a finger-swipe. To form this dynamic gesture, the tip (i.e., distal end) of the thumb may be moved across the index finger from the base (i.e., proximal end) of the index finger to the tip of the index finger (or vice versa). As shown in FIG. 5, the finger-swipe dynamic gesture may be detected by tracking a movement of a first keypoint 501 corresponding to the tip of the thumb relative to the movement of (i) a second keypoint 502 corresponding to the base of the index finger and (ii) a third keypoint 503 corresponding to the tip of the index finger.

Detection of the finger-swipe gesture may include determining that the second keypoint 502 and the third keypoint 503 are approximately stationary while the first key point 501 moves. A direction of the first keypoint 501 movement (i.e., swipe direction) may be determined based on starting and stopping positions of the first keypoint 501. The finger-swipe dynamic gesture may be used to perform system/user-interface (sys/UI) and application functions including (but not limited to) pointing, deleting, selecting, scroll, and the like.

FIG. 6B illustrates a second possible dynamic gesture according to an implementation of the present disclosure. The dynamic gesture shown in FIG. 6B is a finger-pinch. To form this dynamic gesture, the tip of the index finger and the tip of the thumb may be moved from being spaced-apart to touching. As shown in FIG. 5, the finger-pinch dynamic gesture may be detected by tracking a movement of the first keypoint 501 corresponding to the tip of the thumb relative to a movement of the third keypoint 503 corresponding to the tip of the index finger.

Detection of the finger-pinch gesture may include determining that the first keypoint 501 and third keypoint 503 are moved to approximately the same position. A duration of the movement (i.e., long finger press, short finger press) may be determined based on the sequence of high-resolution images in which the first keypoint 501 and the third keypoint 503 are proximate (e.g., within a predetermined distance). The finger press dynamic gesture may be used to perform sys/UI and application functions including (but not limited to) confirming, navigating back, waking, sleeping, and the like.

A reduced complexity hand model may be referred to as a sparse keypoint model because it includes less than 21 keypoints of the full keypoint model. The gesture detection may require a sparse keypoint model. The sparse keypoint model reduces a complexity (i.e., reduces layers, nodes) of the first neural network used for the keypoint generation, which in turn, reduces the power consumed by the second processor.

A sparse keypoint model may be sufficient for other applications besides recognizing dynamic gestures. For example, as shown in FIG. 5, a palm of the hand may be modeled using a fourth keypoint 504 at an upper-left corner of the palm (i.e., base of first finger), the second keypoint 502 at an upper-right corner of the palm (i.e., based on the index finger), a sixth keypoint 506 at a lower-right corner of the palm (i.e., base of the thumb), and a fifth keypoint 505 at a lower-left corner of the palm (e.g., wrist). Tracking the movement and orientation (i.e., pose) of the palm may be used to render palm-locked elements to be displayed in an augmented-reality display.

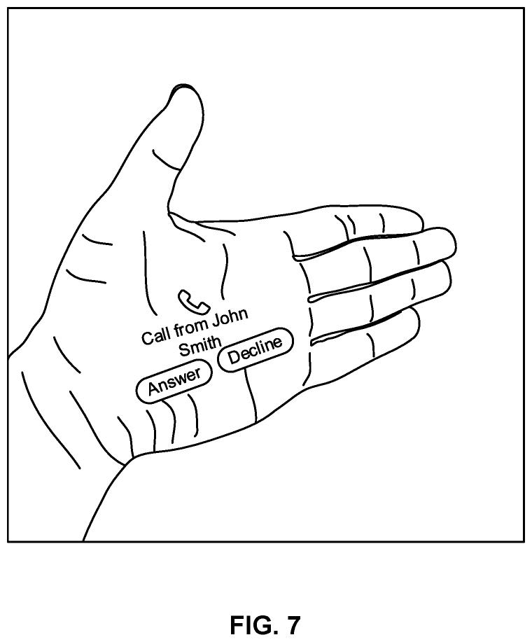

FIG. 7 illustrates a palm-locked rendered element as seen through an augmented reality display according to an implementation of the present disclosure. As shown, the rendered element is a system user-interface screen that includes graphics and text arranged as they would be on a fixed screen but now projected as if the surface of the fixed screen with the palm of the user's hand. The rendered element is palm-locked because it follows the position/orientation (i.e., pose) of the palm as it is moved. The rendered element may not be displayed when the palm is not visible. For example, if the user makes a fist, then the rendered element may disappear from view.

Returning to FIG. 4, the set of keypoints 435 (e.g., sparse set of keypoints) are applied to a tracking/detection algorithm 436. The tracking/detection algorithm 436 can include a tracking calculation (i.e., tracker) configured to track the movements (e.g., relative motion) of the set of keypoints over time. For example, the time may be determined by a frame rate of a sequence of high-resolution images (e.g., video stream). In a first possible implementation, the movements may be applied (i.e., input) to a neural network configured to output a dynamic gesture based on the movements. In a second possible implementation, the movements may be applied (i.e., input) to a neural network configured to output a warping transformation (e.g., warping matrix) based on the movements.

As shown in FIG. 4, the companion device 480 may include a third processor 481 configured to receive the gesture (or warping transformation) from the head-mounted device 410 over a (wireless) communication link (e.g., WiFi direct). The gesture (or warping transformation) may be applied to a rendering algorithm 482 running on (i.e., performed by) the third processor 481 in order to generate a rendered element 483. In a possible implementation, the rendered element can be a sys/UI screen. The rendered element 483 can be transmitted back to the head-mounted device 410 over the (wireless) communication link. In other words, the rendering can use a split-computer architecture including the head-mounted device 410 and the companion device 480. The split-compute architecture for the rendering 482, while not required, may further reduce the power consumed by the head-mounted device 410.

As shown in FIG. 4, the (received) rendered element 483 may be applied to an application 432 running on the second processor 430. The application may drive a display 475 (e.g., heads-up display) of the head-mounted device 410 so that the user can observe the rendered element.

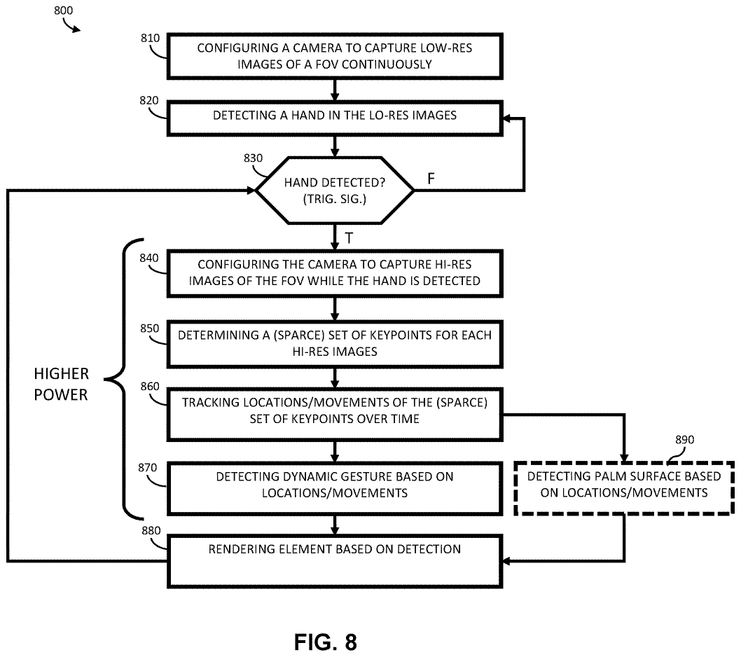

FIG. 8 is a flow chart of a method for tracking a movement of a hand according to an implementation of the present disclosure. The method 800 includes configuring 810 a camera to capture low-resolution images of a field-of-view. In a possible implementation, the camera is a world camera of a head-mounted device 410 that is configured to capture low-resolution images continuously while the head-mounted device is in operation and worn by a user. The method 800 further includes detecting 820 a hand in the low-resolution images.

Here, the hand can be detected in at least one of the low-resolution images, or in a number of subsequent low-resolution images. As described previously, the hand may be detected by a first processor 426 configured by a hand-recognition algorithm 428. In a possible implementation, the hand-recognition algorithm may be trained to recognize a hand of the user and ignore other hands in the field-of-view. The method 800 may further include determining 830 if a hand has been detected. If no hand is detected (i.e., F), then the method 800 may continue searching for a hand in the low-resolution images. If a hand is detected (i.e., T), then the method 800 may track the movement of the hand using a process that consumes a higher power than the hand detection. In a possible implementation, a second processor can be configured to perform the operations of the higher power process.

In the method 800, the higher power process includes configuring 840 the camera to capture high-resolution images of the field of view. In a possible implementation, the camera may be configured to capture high-resolution images while the hand is detected in the low-resolution images. In another possible implementation, the camera may be configured to capture high-resolution images until an application has received a detected gesture. In another possible implementation, the camera may be configured to capture high-resolution images for a fixed period. In a possible implementation, the high-resolution images may be frames of a video stream.

In the method 800, the higher power process further includes determining 850 a set of keypoints for each captured high-resolution image. The set of keypoints may be a sparse (i.e., reduced) set of keypoints. As described previously, the keypoints may be generated by a second processor 430 configured by a keypoint-generation algorithm 434. In a possible implementation, the (sparse) set of keypoints may include four or fewer keypoints to model a hand of the user.

In the method 800, the higher power process further includes tracking 860 locations/movements of the sparse set keypoints over time. As described previously, the keypoints may be tracked by a second processor 430 configured by a tracking/detection algorithm 436. In a first possible implementation, a set of three keypoints is used to track the locations and movements of a thumb and index finger of a hand of the user. In another possible implementation, the set of four keypoints is used to track the location and movement of a palm of the hand of the user.

In the method 800, the higher power process further includes detecting 870 a dynamic gesture based on the tracked location/movements. As described previously, the gestures may be generated by a second processor 430 configured by a tracking/detection algorithm 436. In another possible implementation the higher power process further includes detecting 890 a palm surface based on the tracked location/movements.

The method 800 further includes rendering 880 an element based on the detection. As mentioned previously the rendering may be performed by a companion device 480 in a split-computing architecture with the head-mounted device 410. In particular a third processor 481 configured by a rendering algorithm 482 may generate the rendered element 483. The rendered element may then be transmitted from the companion device 480 to the head-mounted device 410 for presentation on a display 475.

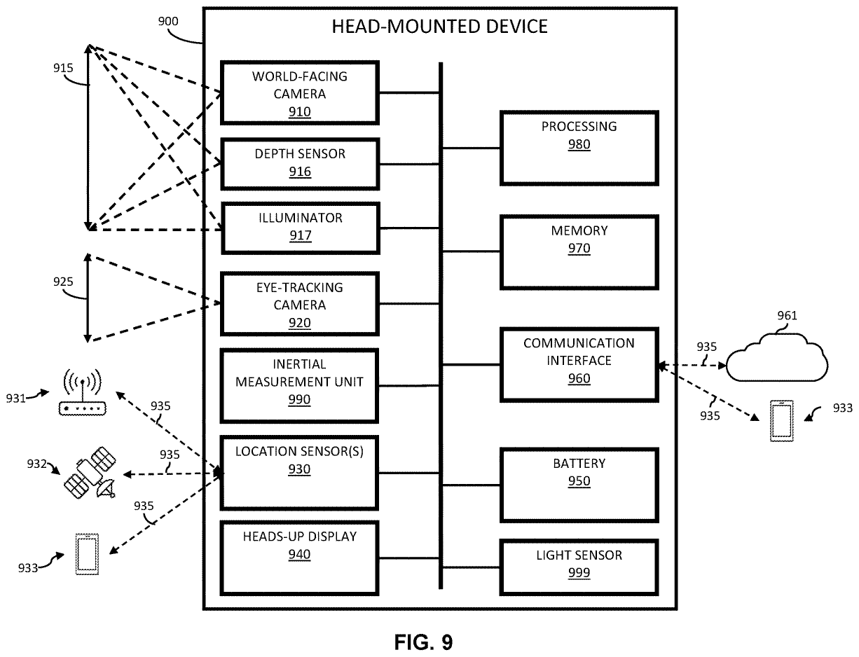

FIG. 9 is a system block diagram of a head-mounted device according to a possible implementation of the present disclosure. As mentioned, the head-mounted device 900 (i.e., head-worn device) may be implemented as smart glasses worn by a user. In a possible implementation, the smart glasses may provide a user with (and enable a user to interact with) an augmented reality (AR) environment. In these implementations, the smart glasses may be referred to as AR glasses. While AR glasses are not the only possible head-mounted device that can be implemented using the disclosed systems and methods (e.g., virtual reality headset), the disclosure may refer to the AR glasses implementation as the head-mounted device throughout the disclosure.

The head-mounted device 900 may be worn on the head of a user (i.e., wearer) and can be configured to monitor a position and orientation (i.e., pose) of the head of the user. Additionally, the head-mounted device 900 may be configured to monitor the environment of the user. The head-mounted device may be further configured to determine a frame coordinate system based on the pose of the user and a world coordinate system based on the environment of the user. The relationship between the frame coordinate system and the world coordinate system may be used to visually anchor digital objects to real objects in the environment. The digital objects may be displayed to a user in a heads-up display. For these functions the head-mounted device 900 may include a variety of sensors and subsystems.

The head-mounted device 900 may include a world-facing camera 910. The world-facing camera (i.e., front-facing camera) may be configured to capture images of a front field-of-view 915. The front field-of-view 915 may be aligned with a user's field of view so that the front-facing camera captures images from a point-of-view of the user. The camera may be a charge coupled device (CCD) or complementary metal oxide semiconductor (CMOS) sensor that may have an adjustable frame rate and resolution. For example, the camera may be configured in a high-resolution mode in which it captures higher resolution images than when it is configured in a low-resolution mode.

The head-mounted device 900 may further include an eye-tracking camera 920 (or cameras). The eye tracking camera may be configured to capture images of an eye field-of-view 925. The eye field of view 925 may be aligned with an eye of the user so that the eye-tracking camera 920 captures images of the user's eye. The eye images may be analyzed to determine a gaze direction of a user, which may be included in analysis to refine the frame coordinate system to better align with a direction in which the user is looking. When the head-mounted device 900 is implemented as smart glasses, the eye-tracking camera 920 may be integrated with a portion of a frame of the glasses surrounding a lens to directly image the eye. In a possible implementation the head-mounted device 900 includes an eye-tracking camera 920 for each eye and a gaze direction may be based on the images of both eyes.

The head-mounted device 900 may further include a depth sensor 916 (i.e., range detector) configured to measure a range of objects in (at least) the front field-of-view 915 and an illuminator configured to transmit light (e.g., near infra-red light) into (at least) the front field-of-view 915 to aid function of the world-facing camera 910 and/or the depth sensor 916.

The head-mounted device 900 may further include location sensors 930. The location sensors may be configured to determine a position of the head-mounted device (i.e., the user) on the planet, in a building (or other designated area), or relative to another device. For this, the head-mounted device 900 may communicate with other devices over a wireless communication link 935. For example, a user's position may be determined within a building based on communication between the head-mounted device 900 and a wireless router 931 or indoor positioning unit. In another example, a user's position may be determined on the planet based on a global positioning system (GPS) link between the head-mounted device 900 and a GPS satellite 932 (e.g., a plurality of GPS satellites). In another example, a user's position may be determined relative to a device (e.g., mobile phone 933) based on ultra-wide band (UWB) communication or Bluetooth communication between the mobile phone 933 and the location sensors 930.

The head-mounted device 900 may further include a display 940. For example, the display 940 may be a heads-up display (i.e., HUD) displayed on a portion (e.g., the entire portion) of a lens of AR glasses. In a possible implementation, a projector positioned in a frame arm of the glasses may project light to a surface of a lens, where it is reflected to an eye of the user. In another possible implementation, the head-mounted device 900 may include a display for each eye.

The head-mounted device 900 may further include a battery 950. The battery may be configured to provide energy to the subsystems, modules, and devices of the head-mounted device 900 to enable their operation. The battery may be rechargeable and have an operating life (e.g., lifetime) between charges. The head-mounted device 900 may include circuitry or software to monitor a battery level of the battery 950.

The head-mounted device 900 may further include a communication interface 960. The communication interface may be configured to communicate information digitally over a wireless communication link (e.g., WiFi, Bluetooth, etc.). For example, the head-mounted device 900 may be communicatively coupled to a network 961 (i.e., the cloud) or a device (e.g., the mobile phone 933) over a wireless communication link 935. The wireless communication link may allow operations of a computer-implemented method to be divided between devices (i.e., split-processing). Additionally, the communication link may allow a device to communicate a condition, such as a battery level or a power mode (e.g., low-power mode). In this regard, devices communicatively coupled to the head-mounted device 900 may be considered as accessories to the head-mounted device 900 and therefore each may be referred to as an accessory device. In a possible implementation, an accessory device (e.g., mobile phone 933, tablet) may be configured to detect a gesture and then communicate this detection to the head-mounted device 900 to trigger a response from the head-mounted device 900.

The head-mounted device 900 may further include a memory 970. The memory may be a non-transitory computer readable medium (i.e., CRM). The memory may be configured to store a computer program product. The computer program can instruct a processor to perform computer implemented methods (i.e., computer programs). These computer programs (also known as modules, programs, software, software applications or code) include machine instructions for a programmable processor and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The head-mounted device 900 may further include a processor 980. The processor may be configured to carry out instructions (e.g., software, applications, etc.) to configure the functions of the head-mounted device 900. In a possible implementation the processor may include multiple processor cores. In a possible implementation, the head-mounted computing device may include multiple processors. In a possible implementation, processing for the head-mounted computing device may be carried out over a network 961.

The head-mounted device 900 may further include an inertial measurement unit (IMU 990). The IMU may include a plurality of sensor modules to determine its position, orientation, and/or movement. The IMU may have a frame coordinate system (X, Y, Z) and each sensor module may output values relative to each direction of the frame coordinate system.

The head-mounted device 900 may further include a light sensor 999 configured to measure an ambient light level. In a possible implementation the light sensor 999 output may trigger a low-light condition when the measured ambient light is at or below a low-light threshold. In a possible implementation, the low-light condition can trigger the illuminator 917.

In the following, some examples of the disclosure are described.

Example 1. A head-mounted device comprising: a camera 420 configured to: capture low-resolution images 427 of a field-of-view 424 continuously; and capture high-resolution images 429 of the field-of-view 424 while being triggered by a trigger signal 425; a first processor 426 configured to: generate the trigger signal 425 while a hand is recognized in the low-resolution images 427; and a second processor 430 activated by the trigger signal 425 to: determine a set of keypoints 435 for each of the high-resolution images 429, the set of keypoints for each high-resolution image corresponding to locations on the hand in the field-of-view 424; and track movements of the set of keypoints 435 over time.

Example 2. The head-mounted device according to example 1, wherein the set of keypoints 435 includes 4 or fewer keypoints.

Example 3. The head-mounted device according to examples 1 or 2, wherein the set of keypoints 435 includes locations of a thumb and an index finger of the hand in the high-resolution images 429.

Example 4. The head-mounted device according to example 3, wherein the set of keypoints 435 includes a first keypoint located at a distal end of the index finger, a second keypoint located at a proximal end of the index finger, and a third keypoint located at a distal end of the thumb.

Example 5. The head-mounted device according to example 4, wherein the second processor 430 is further configured to: detect a dynamic gesture based on the movements of the set of keypoints over time; transmit the dynamic gesture to a companion device that is in communication with the head-mounted device; receive a rendered element 483 from the companion device, the rendered element 483 based on the dynamic gesture; and display the rendered element 483 on a display of the head-mounted device.

Example 6. The head-mounted device according to example 5, wherein for a particular high-resolution image the second processor 430 is configured to compute: a first neural network to detect the set of keypoints from pixels of the particular high-resolution image; and a second neural network to detect the dynamic gesture based on (i.e., from) the set of keypoints. The term “particular” can be used to refer to any one of the high-resolution images, such as for example to the first, the last, or a randomly selected image of the high-resolution images.

Example 7. The head-mounted device according to examples 5 or 6, wherein the dynamic gesture is a finger-swipe corresponding to a scroll, a finger-pinch corresponding to a short click, and/or a long-finger-pinch corresponding to a click and hold.

Example 8. The head-mounted device according to any of examples 5 through 7, wherein the rendered element 483 is a system user-interface screen.

Example 9. The head-mounted device according to examples 1 or 2, wherein the set of keypoints 435 includes a first keypoint corresponding to an upper-left palm corner, a second point corresponding to an upper-right palm corner, a third keypoint corresponding to a lower-left palm corner, and a fourth keypoint corresponding to a lower-right palm corner.

Example 10. The head-mounted device according to example 9, wherein the second processor 430 is further configured to: detect a palm surface based on the set of keypoints 435; transmit the palm surface to a companion device that is in communication with the head-mounted device; receive a palm-locked element from the companion device, the palm-locked element being warped based on the palm surface; and display the palm-locked element on a display 475 of the head-mounted device so that it appears on the palm surface.

Example 11. The head-mounted device according to any of the preceding examples, wherein the first processor 426 is included in the camera 420 and the second processor 430, being separate from the first processor 426, is external to the camera 420.

Example 12. The head-mounted device according to any of the preceding examples, wherein: the low-resolution images 427 are captured at lower resolution and at a lower frame rate than the high-resolution images 429; and the low-resolution images 427 are grayscale, and the high-resolution images 429 are color.

Example 13. The head-mounted device according to any of the preceding examples, wherein for a particular low-resolution image the first processor 426 is configured to compute: a neural network to detect the hand from pixels of the particular low-resolution image.

Example 14. A method for tracking a movement of a hand, the method comprising: configuring a camera to capture low-resolution images of a field-of-view continuously; detecting a hand in the low-resolution images; triggering the camera to capture high-resolution images of the field-of-view while the hand is recognized in the low-resolution images; determine a set of keypoints for each of the high-resolution images, the set of keypoints for each high-resolution images corresponding to locations on the hand in the field-of-view; and track movements of the set of keypoints over time.

Example 15. The method according to example 14, wherein the set of keypoints includes locations of a thumb and an index finger of the hand in the high-resolution images.

Example 16. The method according to example 14 or 15, wherein the set of keypoints includes a first keypoint located at a distal end of the index finger, a second keypoint located at a proximal end of the index finger, and a third keypoint located at a distal end of the thumb.

Example 17. The method according to example 16, further comprising: detecting a dynamic gesture based on the movements of the set of keypoints over time; generating a rendered element based on the dynamic gesture; and displaying the rendered element on a display of a head-mounted device.

Example 18. The method according to example 17, wherein: the dynamic gesture is a finger-swipe corresponding to a scroll, a finger-pinch corresponding to a short click, and/or a long-finger-pinch corresponding to a click and hold; and the rendered element is a system user-interface screen.

Example 19. The method according to any of examples 14 through 15, wherein the set of keypoints includes a first keypoint corresponding to an upper-left palm corner, a second point corresponding to an upper-right palm corner, a third keypoint corresponding to a lower-left palm corner, and a fourth keypoint corresponding to a lower-right palm corner.

Example 20. The method according to example 19, further comprising: detecting a palm surface based on the set of keypoints; warping a palm-locked element based on the palm surface; and displaying the palm-locked element on an augmented reality display so that it appears on the palm surface.

Example 21. A system 400 for dynamic gesture detection comprising: a head-mounted device 410 including: a camera 420 configured to configured to: capture low-resolution images 427 of a field-of-view 424 continuously; and capture high-resolution images 429 of the field-of-view 424 while being triggered by a trigger signal 425; a first processor 426 configured to: generate the trigger signal 425 while a hand is recognized in the low-resolution images 427; and a second processor 530 activated by the trigger signal 425 to: determine a set of keypoints 435 for each of the high-resolution images 429, the set of keypoints 435 for each high-resolution image corresponding to locations on the hand in the field-of-view 424; track movements of the set of keypoints 435 over time; and detect a dynamic gesture based on the movements of the set of keypoints over time; and a companion device 480 in communication with the head-mounted device 410, the companion device 480 including a third processor 481 configured to: receive the dynamic gesture from the head-mounted device 410; generate a rendered element 483 based on the dynamic gesture; and transmit the rendered element 483 to the head-mounted device 410 for display.

Example 22. The system 400 for dynamic gesture detection according to example 21, wherein the head-mounted device 410 is smart glasses and the companion device 480 is a mobile phone.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A head-mounted device comprising:
a camera configured to:
capture low-resolution images of a field-of-view; and
capture high-resolution images of the field-of-view in response to being triggered by a trigger signal;
a first processor configured to:
generate the trigger signal in response to a hand being identified in the low-resolution images; and
a second processor activated by the trigger signal to:
determine a set of keypoints for each high-resolution image corresponding to locations on the hand in the field-of-view.

2. The head-mounted device according to claim 1, wherein the set of keypoints includes 4 or fewer keypoints.

3. The head-mounted device according to claim 1 or 2, wherein the set of keypoints includes locations of a thumb and an index finger of the hand in the high-resolution images.

4. The head-mounted device according to claim 3, wherein the set of keypoints includes a first keypoint located at a distal end of the index finger, a second keypoint located at a proximal end of the index finger, and a third keypoint located at a distal end of the thumb.

5. The head-mounted device according to claim 4, wherein the second processor is further configured to:
track movements of the set of keypoints over time;
detect a dynamic gesture based on the movements of the set of keypoints over time;
transmit the dynamic gesture to a companion device that is in communication with the head-mounted device;
receive a rendered element from the companion device, the rendered element based on the dynamic gesture; and
display the rendered element on a display of the head-mounted device.

6. The head-mounted device according to claim 5, wherein for a particular high-resolution image the second processor is configured to compute:
a first neural network to detect the set of keypoints from pixels of the particular high-resolution image; and
a second neural network to detect the dynamic gesture based on the set of keypoints.

7. The head-mounted device according to claim 5 or 6, wherein the dynamic gesture is a finger-swipe corresponding to a scroll, a finger-pinch corresponding to a short click, and/or a long-finger-pinch corresponding to a click and hold.

8. The head-mounted device according to any of claims 5 to 7, wherein the rendered element is a system user-interface screen.

9. The head-mounted device according to claim 1 or 2, wherein the set of keypoints includes a first keypoint corresponding to an upper-left palm corner, a second keypoint corresponding to an upper-right palm corner, a third keypoint corresponding to a lower-left palm corner, and a fourth keypoint corresponding to a lower-right palm corner.

10. The head-mounted device according to claim 9, wherein the second processor is further configured to:
detect a palm surface based on the set of keypoints;
transmit the palm surface to a companion device that is in communication with the head-mounted device;
receive a palm-locked element from the companion device, the palm-locked element being warped based on the palm surface; and
display the palm-locked element on a display of the head-mounted device so that it appears on the palm surface.

11. The head-mounted device according to any of the preceding claims, wherein the first processor is included in the camera and the second processor, being separate from the first processor, is external to the camera, the first processor consuming less power than the second processor.

12. The head-mounted device according to any of the preceding claims, wherein:
the low-resolution images are captured at lower resolution and at a lower frame rate than the high-resolution images; and
the low-resolution images are grayscale, and the high-resolution images are color.

13. The head-mounted device according to any of the preceding claims, wherein for a particular low-resolution image the first processor is configured to compute:
a neural network to detect the hand from pixels of the particular low-resolution image.

14. A method for tracking a movement of a hand, the method comprising:
configuring a camera to capture low-resolution images of a field-of-view;
detecting a hand in the low-resolution images;
triggering the camera to capture high-resolution images of the field-of-view while the hand is recognized in the low-resolution images;
determine a set of keypoints for each of the high-resolution images, the set of keypoints for each high-resolution images corresponding to locations on the hand in the field-of-view; and
track movements of the set of keypoints over time.

15. The method according to claim 14, wherein the set of keypoints includes locations of a thumb and an index finger of the hand in the high-resolution images.

16. The method according to claim 14 or 15, wherein the set of keypoints includes a first keypoint located at a distal end of the index finger, a second keypoint located at a proximal end of the index finger, and a third keypoint located at a distal end of the thumb.

17. The method according to claim 16, further comprising:
detecting a dynamic gesture based on the movements of the set of keypoints over time;
generating a rendered element based on the dynamic gesture; and
displaying the rendered element on a display of a head-mounted device.

18. The method according to claim 17, wherein:
the dynamic gesture is a finger-swipe corresponding to a scroll, a finger-pinch corresponding to a short click, and/or a long-finger-pinch corresponding to a click and hold; and
the rendered element is a system user-interface screen.

19. The method according to claim 14 or 15, wherein the set of keypoints includes a first keypoint corresponding to an upper-left palm corner, a second point corresponding to an upper-right palm corner, a third keypoint corresponding to a lower-left palm corner, and a fourth keypoint corresponding to a lower-right palm corner.

20. The method according to claim 19, further comprising:
detecting a palm surface based on the set of keypoints;
warping a palm-locked element based on the palm surface; and
displaying the palm-locked element on an augmented reality display so that it appears on the palm surface.

21. A system for dynamic gesture detection comprising:
a head-mounted device including:
a camera configured to configured to:
capture low-resolution images of a field-of-view continuously; and
capture high-resolution images of the field-of-view while being triggered by a trigger signal;
a first processor configured to:
generate the trigger signal while a hand is recognized in the low-resolution images; and
a second processor activated by the trigger signal to:
determine a keypoint for each of the high-resolution images, the keypoint for each high-resolution image corresponding to a location on the hand in the field-of-view;
track movements of the keypoint over time; and
detect a dynamic gesture based on the movements of the keypoint over time; and
a companion device in communication with the head-mounted device, the companion device including a third processor configured to:
receive the dynamic gesture from the head-mounted device;
generate a rendered element based on the dynamic gesture; and
transmit the rendered element to the head-mounted device for display.

22. The system for dynamic gesture detection according to claim 21, wherein the head-mounted device is smart glasses and the companion device is a mobile phone.
